(19) United States
(12) Patent Application Publication
(10) Pub. No.: US 2025/0162855 A1
(43) Pub. Date: May 22, 2025

(54) DOSING DEVICE FOR DOSING LIQUIDS

(71) Applicant: Festo SE & Co. KG, Esslingen (DE)

(72) Inventor: Martin BOCHTERLE, Fellbach (DE)

(21) Appl. No.: 18/952,318

(22) Filed: Nov. 19, 2024

(30) Foreign Application Priority Data
Nov. 22, 2023 (DE) 10 2023 132 501.9

(51) Int. Cl. B67D 3/00; G01F 22/02

(52) U.S. Cl. CPC B67D 3/0041; B67D 3/0077; G01F 22/02

(57) ABSTRACT

Dosing device for dosing liquids, with a channel plate in which a fluid channel is formed that extends between a supply connection and an output connection, with a supply valve assigned to the supply connection and with an output valve assigned to the output connection, and with a controller which is electrically connected to the supply valve and the output valve. A tip coupling for coupling a pipetting tip is associated with the output connection and the supply valve and/or the output valve is/are designed as a proportional valve.

### CROSS-REFERENCE TO RELATED APPLICATIONS

This application claims the benefit of German application DE 10 2023 132 501.9 filed Nov. 22, 2023, which is incorporated herein by reference.

The invention relates to a dosing device for dosing liquids.

DE 10 2020 205 073 A1 discloses a dosing device for dosing liquids, comprising a fluid unit for optionally providing an overpressure and an underpressure to a working gas that is received in a fluid channel, which is connected to the fluid unit at a first end region and which comprises a second end region designed to receive and discharge a predeterminable liquid volume, with a first valve device and with a second valve device, which are arranged spaced apart from one another along the fluid channel and are each designed to optionally block or release the fluid channel in order to fluid reservoir, which is bounded by the two valve devices and is intended for storing working gas, with a controller for controlling the valve devices, the fluid reservoir being assigned a pressure sensor which is designed to provide a pressure signal as a function of a working gas pressure and is electrically connected to the controller.

### SUMMARY OF THE INVENTION

The object of the invention is to provide a dosing device with which a higher dosing precision can be achieved.

This object is solved for a dosing device of the type as mentioned above with the following features: dosing device for dosing liquids, with a channel plate in which a fluid channel is formed which extends between a supply connection and an output connection, with a supply valve associated with the supply connection and with an output valve associated with the output connection, and with a controller that is electrically connected to the supply valve and the output valve, wherein a tip coupling for connecting a pipetting tip is associated with the output connection and wherein the supply valve and/or the output valve is designed as a proportional valve.

The channel plate, which can also be referred to as a channel board or a base body, has a fluid channel passing through it, which fluid channel provides a fluid connection between the supply connection and the output connection. For example, a fluid module, in particular designed as a combination of a fluid source and a fluid sink, can be connected to the supply connection, with the aid of which a pressurized fluid and a vacuum can be supplied to the fluid channel as required. For example, the channel plate is formed in one piece or in several pieces, in particular as a component produced in a plastic injection molding process.

A tip coupling is assigned to the output connection, which is designed for coupling a pipetting tip. A pipetting tip is a tube, preferably made of a plastic material, in particular tapered with a conical shape, which is intended for the temporary holding of a liquid. Pipetting tips of this kind are used in particular in the field of laboratory technology for dispensing liquids. The tip coupling associated with the output port for connecting the pipetting tip is designed to hold the pipetting tip in a fluid-tight manner so that neither a pressurized fluid nor a liquid contained in the pipetting tip can escape between the coupling and the pipetting tip.

The task of the supply valve assigned to the supply connection is to open or close a fluidically communicating connection between the fluid module that can be connected to the supply connection and a section of the fluid channel that extends between the supply valve and the output valve. As a result, the supply valve has the function of releasing or blocking a corresponding pressurization of the fluid channel with positive pressure or a corresponding pressurization of the fluid channel with negative pressure, depending on the positive pressure or negative pressure provided at the supply connection by the fluid module.

The task of the output valve, which is assigned to the output connection is to selectively open or close a fluidically communicating connection between the section of the fluid channel extending between the supply connection and the output valve and the output connection with the assigned tip coupling. The output valve is thus used to selectively enable or block pressure equalization between an environment of the dosing device and the fluid channel, wherein aspiration of a liquid into the pipetting tip or dispensing of a liquid out of the pipetting tip is effected in the course of this pressure equalization.

In this case, at least one valve from the group: supply valve, output valve, is designed as a proportional valve, wherein a predeterminable valve opening can be provided by the proportional valve in dependence on an electrical control signal which is provided by the controller. In this case, the proportional valve can be adjusted continuously variable between a fully closed functional state and a fully open functional state. It is preferably provided that there is a proportional relationship between the control signal, which is in particular an electrical control voltage that can be predetermined by the controller or an electrical control current that can be predetermined by the controller, and the functional state of the proportional valve. However, depending on the design of the proportional valve and of an actuator belonging to the proportional valve and responsible for converting the electrical energy provided by the controller into a mechanical movement, there may be a non-proportional relationship between the control signal and the functional state of the proportional valve instead of a proportional relationship.

The controller is, for example, a microprocessor or microcontroller and executes a stored computer program. Preferably, the controller is connected to a higher-level control system that is designed to provide control commands to the controller. The control commands are directed to a change in the functional state of the supply valve and/or of the output valve. This higher-level control can, for example, be a machine control for a laboratory robot which, for example, has a receiving surface for a multiplicity of sample containers and a manipulator for a one-dimensional, two-dimensional, or three-dimensional relative movement of the dosing device with respect to the sample containers. Alternatively, the controller can be connected to a switching device, in particular one that is fixed to the channel plate, which can be operated by an operator in order to provide switching commands for the supply valve and the output valve directly to the controller.

Advantageous further developments of the invention are the subject of the sub-claims.

It is useful if the fluid channel is connected to a vacuum connection formed on the channel plate, and that a vacuum valve, in particular a proportional valve, is associated with the vacuum connection and is electrically connected to the controller. With the additional vacuum connection, a vacuum source intended solely for providing a vacuum can be connected to the vacuum connection and a fluid source intended solely for providing a pressurized fluid is connected to the supply connection. As a result, a faster provision of overpressure or underpressure (vacuum) in the fluid channel of the channel plate can be achieved due to shorter fluidic paths. This means that the dosing device can be switched over more quickly, for example, between a suction process for sucking a liquid into the pipetting tip and a dispensing process for dispensing the liquid out of the pipetting tip. Preferably, the vacuum valve is designed as a proportional valve in order to be able to be adjusted in a manner similar to the supply valve and/or the output valve in a stepless manner between a fully closed state and a fully open state by the controller.

It is preferred that at least one valve from the group: supply valve, output valve, vacuum valve, is designed as a piezoelectric valve, preferably as a piezoelectric bender valve, in particular as a 3/3-way piezoelectric bender valve. The use of piezoelectric valves, which have at least one actuator made of a piezoelectric material, allows a compact design for the respective valve. Furthermore, a piezoelectric valve has a considerably lower self-heating compared to a solenoid valve, since a piezoelectric valve is operated with a high voltage (in particular greater than 300 V), but with a low current and has a low mass compared with a solenoid valve. It follows that heating of the dosing device, the pipetting tip connected to it and the liquid absorbed in the pipetting tip can be kept at a lower level compared with a solenoid valve.

In an advantageous embodiment of a piezoelectric valve, the piezoelectric actuator is designed in the form of a strip and is applied to a carrier material, in particular a spring steel, which is also designed in the form of a strip. By applying a suitable control voltage to the piezoelectric actuator, a curvature of the composite of piezoelectric actuator and carrier material, also known as a piezo bender, can be influenced. This allows to move a sealing element, which is attached to the piezo bender, to be placed on a valve seat formed in the fluid channel to block the fluid channel or to be lifted off this valve seat to release the fluid channel. It is particularly advantageous if such a piezo bender can be bent in opposite directions by suitable arrangement of several piezoelectric layers on the carrier material and has several sealing elements, to realize a 3/3-way valve function. Such a proportional valve, for example, has a first input connection, a second input connection and a working connection, wherein, depending on an electrical actuation of the piezoelectric bender, a fluidically communicating connection between the first input connection and the working connection or between the second input connection and the working connection can be optionally closed or released.

For a dosing device, a 3/3-way piezo valve of this kind can be used in such a way that the 3/3-way piezo valve realizes the supply valve function and the vacuum valve function and is accommodated in a first valve housing, which has a first input connection, which is connected to the supply connection, and a second input connection, which is connected to the vacuum connection, and a first working connection which is formed on the first valve housing and is connected to the output valve. The 3/3-way piezo valve is capable of blocking or releasing a first fluid path between the first input connection and the first working connection. Furthermore the 3/3-way piezo valve is capable of blocking or releasing a second fluid path between the second input connection and the first working connection.

Provided that a fluid source is connected to the supply connection and a fluid sink (vacuum supply) is connected to the vacuum connection, a freely selectable and quickly switchable application of pressure or vacuum can be provided at the working connection using such a 3/3-way piezoelectric valve.

In a further development of the invention, it is envisaged that the output valve is accommodated in a second valve housing which has a second input connection that is connected to the first working connection of the first valve housing and which has a second working connection that is connected to the output connection. It is preferably provided that the output valve is also designed as a 3/3-way piezo valve, so that the valves of the dosing device are realized as identical parts. However, in the case of the output valve, only the second input connection and the working connection are used, while the first input connection remains unused. Accordingly, the output valve is operated only as a 2/2-way piezo valve.

In a further development of the invention, it is envisaged that the fluid channel has a first valve shaft, which is designed to receive the first valve housing, and a second valve shaft, which is designed to receive the second valve housing. The first valve shaft and the second valve shaft are incorporated as recesses in the channel plate. It is preferably provided that a section of the fluid channel starting from the supply connection and a section of the fluid channel starting from the vacuum connection open into the first valve shaft. It is also provided that a further section of the fluid channel extends between the first valve shaft and the second valve shaft and opens into the two valve shafts. In addition, it is envisaged that a section of the fluid channel, connected to the output connection, extends from the second valve shaft. The first valve shaft and the second valve shaft are designed in such a way that the first valve housing and the second valve housing are connected to the respective sections of the fluid channel in a fluidically communicating manner by means of their respective inlet connections and output connections. Preferably, the first valve shaft and the second valve shaft are designed in such a way that, when the first valve housing or the second valve housing is inserted, connections between the input connections and the associated sections of the fluid channel and the output connections and the associated sections of the fluid channel are established and are fluid-tight with respect to the environment.

Preferably, a maximum dosing volume is determined by a first volume of the first valve housing, by a second volume of the second valve housing and by a fluid channel section extending between the first valve housing and the second valve housing. In particular a volume fraction of the fluid channel section with respect to the maximum dosing volume is less than 20 percent, preferably less than 10 percent. In particular, it is envisaged that the maximum dosing volume is determined by the first valve housing, the fluid channel section extending between the first valve housing and the second valve housing, the second valve housing and, if applicable, a section of the fluid channel extending between the second valve housing and the output connection. In this case, the volume fraction of the fluid channel section in this maximum dosing volume is less than 20 percent, in particular less than 10 percent. Since the valve housings have to be manufactured with a high degree of precision for the respective valves to function properly, it is advantageous for the definition of the maximum dosing volume if the maximum dosing volume is determined predominantly by the volume of the valve housings, so that somewhat lower demands can be placed on the precision of the fluid channel section.

It is useful if a first pressure sensor arrangement, which is electrically connected to the controller, is arranged between the first valve shaft and the second valve shaft, and if a second pressure sensor arrangement, which is electrically connected to the controller, is assigned to the output connection. In this case, the first pressure sensor arrangement serves to determine the pressure in the dosing volume, which is determined by the first valve housing, the second valve housing and the fluid channel section connecting the first valve housing and the second valve housing. A suction process for sucking for liquid into the pipetting tip and a dispensing process for dispensing liquid out of the pipetting tip are mainly determined by the pressure in the dosing volume. The second pressure sensor arrangement serves to determine the actual pressure present at the pipetting tip, in order to be able to carry out a particularly advantageous control for the dosing process.

In a further embodiment of the invention, it is provided that the first pressure sensor arrangement comprises a first pressure sensor with a first measuring range and a second pressure sensor with a second measuring range, wherein the first measuring range and the second measuring range overlap and therefore have an intersection. By using two pressure sensors with different measuring ranges for the first pressure sensor arrangement, an advantageous improvement in measuring accuracy is achieved compared to a pressure sensor with only a single pressure sensor, since, for example, the first pressure sensor can have a high precision in the vacuum range and the second pressure sensor can have a high precision in the overpressure range. The measuring ranges of the two pressure sensors are selected such that they overlap. This means that the controller, which is electrically connected to the two pressure sensors, can also check the function of the two pressure sensors by comparing the sensor signals in the pressure range in which the two measuring ranges overlap.

In an advantageous embodiment of the invention, it is provided that a feed pump, in particular in the form of a diaphragm pump, is assigned to the supply connection and/or that a vacuum pump, in particular in the form of a diaphragm pump, is assigned to the vacuum connection.

### BRIEF DESCRIPTION OF DRAWINGS

An advantageous embodiment of the invention is shown in the drawings. Here shows:

FIG. 1 a strictly schematic overview of a dosing device with a channel plate, valve arrangements accommodated therein, and a controller, and

FIG. 2 a strictly schematic sectional view of a valve assembly with a Piezobieger accommodated therein.

### DETAILED DESCRIPTION OF INVENTION

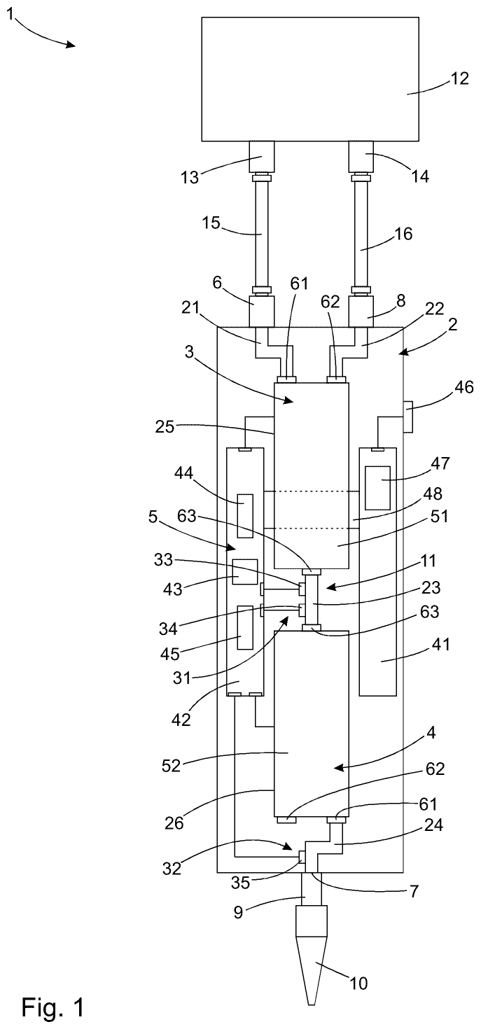

A dosing device 1, shown schematically in FIG. 1, is designed for use in laboratory automation and is used to dose liquid samples and reagents. For example the dosing device 1 may be attached to a manipulator of a laboratory machine (not shown), so that the dosing device 1 can be moved, for example, over a surface on which sample containers (not shown) are arranged, in order to take up liquid from the sample containers or to deliver liquid into the sample containers.

The dosing device 1 has a channel plate 2, which can also be regarded as the base body of the dosing device 1 and which can optionally be accommodated in a housing (not shown). A first valve arrangement 3, a second valve arrangement 4 and a controller 5 are assigned to the channel plate 2. Furthermore, the channel plate 2 has a supply connection 6, an output connection 7 and a vacuum connection 8. A tip coupling 9, which is only shown schematically, is attached to the output connection 7, and a pipetting tip 10 is coupled to said tip coupling 9.

A fluid channel 11 passes through the channel plate 2, which is defined by a first fluid channel section 21, a second fluid channel section 22, a third fluid channel section 23 and a fourth fluid channel section 24. In this connection, it is envisaged that the first fluid channel section 21, the second fluid channel section 22 and the third fluid channel section 23 are each connected to a first valve shaft 25, which is formed in the channel plate 2. It is also envisaged that the third fluid channel section 23 and the fourth fluid channel section 24 are connected to a second valve shaft 26, which is formed in the channel plate 2. By way of example, the fluid channel sections 21 to 24 are each formed as bores in the channel plate 2, while the valve shafts 25, 26 are formed as recesses in the channel plate 2.

In this case, the geometries of the valve shafts 25, 26 are matched to the geometry of a first valve housing 51 of the first valve arrangement 3 and of a second valve housing 52 of the second valve arrangement 4. This ensures that, when the first valve housing 51 is inserted into the first valve shaft 25, fluidically communicating connections are automatically established between the first valve housing 51 and the associated fluid channel sections 21, 22, 23 of the first valve shaft 25, which are, however, sealed with respect to the environment of the channel plate 2. Furthermore, it is ensured that when the second valve housing 52 is inserted into the second valve shaft 26, the respective fluidically communicating connections are established between the second valve housing 52 and the associated fluid channel sections 23 and 24 of the second valve shaft 26, which are likewise sealed with respect to an environment of the channel plate 2. By way of example, it is envisaged that the second valve arrangement 4 is arranged in the channel plate 2 in a mirror-image manner with respect to the first valve arrangement 3, with a dosing chamber being defined by the first valve arrangement 3, the second valve arrangement 4 and the third fluid channel section 23 formed in the channel plate 2 in between.

A supply of overpressure and underpressure is to be provided for operation of the dosing device 1. By way of example only, this supply is provided by a fluid module 12, which comprises for example an overpressure pump (not shown) and an underpressure pump (not shown) and which has a pressure connection 13 and an underpressure connection 14.

The pressure connection 13 is connected to the supply connection 6 of the dosing device 1 via a pressure line 15. The vacuum connection 14 is connected to the vacuum connection 8 of the dosing device via a vacuum line 16.

Furthermore, a supply of electrical energy is required for the operation of the dosing device 1, which electrical energy can be provided via an interface 46 from an electrical energy source (not shown). In addition, it is preferably provided that control commands for the operation of the dosing device from a higher-level controller, for example a machine control of a laboratory robot (not shown) can also be provided at the interface 46. The interface 46 is electrically connected to a communication board 41, which comprises a communication module 47 which is designed to process incoming control commands. The processed control commands and the provided electrical energy are forwarded from the communication board 41 to a control board 42. For this purpose, a cable connection 48, shown only schematically, is provided between the communication board 41 and the control board 42.

The task of the control board 42, which comprises, purely by way of example, a microprocessor 43, a first high-voltage output stage 44 and a second high-voltage output stage 45, is to carry out electrical activation of the valve arrangements 3, 4 and to evaluate sensor signals from the pressure sensor arrangements 31, 32, which are described in more detail below.

The first pressure sensor arrangement 31 comprises a first pressure sensor 33 and a second pressure sensor 34, which are each assigned to the third fluid channel section 23. By way of example, it is envisaged that the first pressure sensor 33 has a measuring range that enables both a precise detection of a vacuum in the third fluid channel section 23 and a slight overpressure in the third fluid channel section 23. Furthermore, it is provided that the second pressure sensor 34 has a measuring range which allows both a precise detection of a slight vacuum and of an overpressure in the third fluid channel section 23. Accordingly, the measuring ranges of the first pressure sensor 33 and the second pressure sensor 34 have an intersection or overlap, which intersection is to be located, for example, in the range of normal pressure (1013 mbar). Both the first pressure sensor 33 and the second pressure sensor 34 are electrically connected to the control board 42 and provide their sensor signals to the microprocessor 43.

The second pressure sensor arrangement 32 comprises a third pressure sensor 35, which is assigned to the fourth fluid channel section 24 and is also electrically connected to the control board 42 in order to be able to provide its sensor signals to the microprocessor 43.

As can be seen from the schematic representation of the first valve arrangement 3 in FIG. 1, the first valve housing 51, which is purely exemplified in the form of a cuboid, has a first inlet connection 61, a second inlet connection 62 and a first working connection 63.

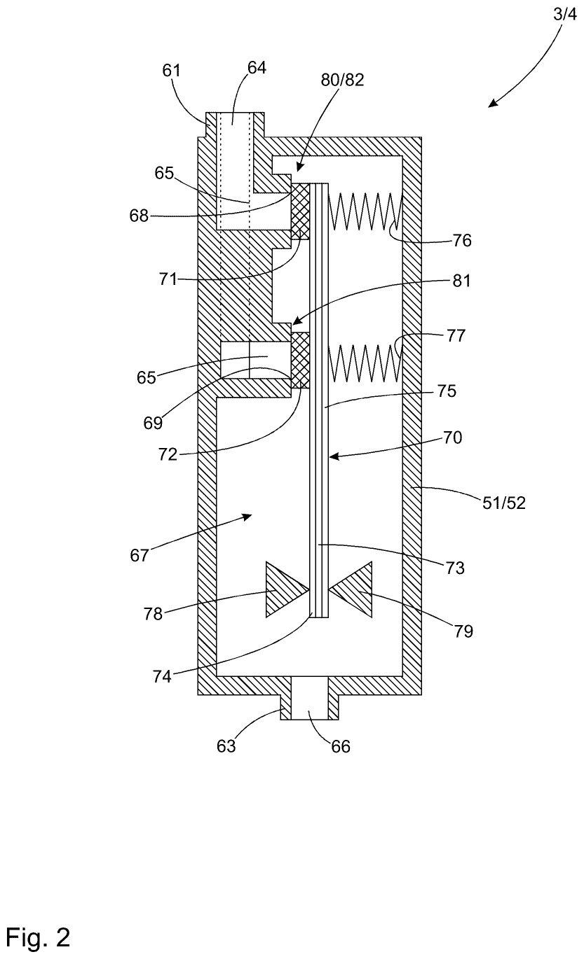

Due to the sectional view of FIG. 2, the second inlet port 62 is hidden by the first inlet port 61 and a second valve channel section 65 associated with the second inlet port 62 according to FIG. 1 is located behind the sectional plane of FIG. 2 in the representation of FIG. 2, which sectional plane is arranged in such a way that a first valve channel section 64 associated with the first inlet port 61 is shown in section. In order to show the course of the second valve channel section 65, it is shown in FIG. 2 as a dashed line and in a somewhat smaller size in some areas.

The first valve channel section 64 opens out into a valve chamber 67 bounded by the first valve housing 51, with an orifice of the first valve channel section 64 forming a first valve seat 68. The second valve channel section 65 also opens out into the valve chamber 67, with an orifice of the second valve channel section 65 forming a second valve seat 69. A third valve channel section 66 connects the valve chamber 67 to the first working connection 63.

A piezo bender 70, which is only shown schematically and is designed in the form of a strip, is arranged in the valve chamber 67 and exemplarily has a carrier layer 73, a first piezoelectric layer 74 and a second piezoelectric layer 75. The first piezoelectric layer 74 is applied to a lower side of the carrier layer 73, while the second piezoelectric layer 75 is applied to an upper side of the carrier layer 73. A first sealing element 71 and a second sealing element 72 are fixed at a distance from each other on a bottom side of the first piezoelectric layer 74, facing away from the carrier layer 73. On an upper side of the second piezoelectric layer 75, which faces away from the carrier layer 73, a first pressure spring 76 and a second pressure spring 77 are arranged opposite the first sealing element 71 and the second sealing element 72, respectively. Each of the first pressure spring 76 and the second pressure spring 77 is supported on an inner surface 53 of the valve housing. Furthermore, the piezo bender 70 is held at an end region facing away from the sealing elements 71, 72 between a first knife-edge bearing 78 and a second knife-edge bearing 79, which ensure a fixed mounting of the piezo bender 70, wherein a change in shape of the piezo bender 70 is not impeded.

The two piezoelectric layers 74, 75 are electrically connected to the control board 42 in a manner not described in detail, so that a (high-voltage) control voltage can be applied to each of the two piezoelectric layers 74, 75. By way of example, the two piezoelectric layers 74, 75 are designed in such a way that applying a drive voltage causes the respective piezoelectric layer 74, 75 to expand. Since the carrier layer 73, by contrast, does not expand, the piezo bender 70 can thus be optionally transferred into a first curvature position (not shown) or into a second curvature position (not shown). Thus, the piezo bender 70 can be used for a valve function in which, depending on the respective control voltage applied to at least one of the two piezoelectric layers 74, 75, either the first sealing element 71 is lifted from the first valve seat 68 or the second sealing element 73 is lifted from the second valve seat 69.

In principle, it can be assumed that there is a predefinable relationship between a control voltage applied to the respective piezoelectric layer 74, 75 and a change in the curvature of the piezoelectric bender 70, so that can be used to optionally set an opening cross-section for the first valve seat 68 or for the second valve seat 69, and thus a proportional valve function is realized by the first valve arrangement 3. Any changes in the bending behavior of the piezoelectric bender 70 that occur during operation of the first valve arrangement 3 can be compensated by monitoring the pressure in the third fluid channel section 23 by means of the first pressure sensor arrangement 31 by means of a control stored in the microprocessor 43.

From FIGS. 1 and 2 it can be seen that, with the aid of the first valve arrangement 3, which, with the first valve seat 68 and the associated first sealing element 71, forms a supply valve 80 and with the second valve seat 69 and the associated second sealing element 72 forms a vacuum valve 81, a pressurized fluid or a vacuum can be optionally supplied to the dosing chamber. Furthermore, an output valve 82 is provided for the dosing chamber, which is of identical design as the first valve arrangement 3. The second valve arrangement 4 comprises a first valve seat 68 and a first sealing element 71. The two valve arrangements 3 and 4 are fluidically connected to one another in a purely exemplary mirror-image fashion, so that the first working connection 63 of the first valve arrangement 3 is connected to the first working connection 63 of the second valve arrangement 4, which is used as the inlet connection, the dosing chamber is defined by the volume of the first valve housing 51 of the first dosing valve 3 and the volume of the second valve housing 52 of the second dosing valve 4 and volume of the third fluid channel section 23 arranged in between the first valve housing 51 and the second valve housing 52. The same designations and reference signs are used for the second valve assembly 4 as for the first valve assembly 3, although from a functional point of view the working connection of the second valve assembly 4 is used as the input connection and the first input connection 61 of the second valve assembly 4 forms a working connection. Furthermore, it should be mentioned that the first valve assembly 3 is used as a 3/3-way proportional valve, while the second valve assembly 4 is used as a 2/2-way proportional valve.

The following procedure is intended for performing a dosing process: provision of a vacuum at the vacuum connection 8 of the dosing device 1 by the fluid module 12; temporarily opening the second valve seat 69 of the first valve arrangement 3 by applying a suitable control voltage to the piezo bender 70, whereby the second sealing element 72 is lifted from the second valve seat 69 and application of a vacuum to the dosing chamber, which dosing chamber is bounded by the first valve housing 51, the second valve housing 52 and the third fluid channel section 23; controlling (closed loop) the application of negative pressure to the dosing chamber on the basis of sensor signals from the first pressure sensor arrangement 31, which sensor signals are provided to the microprocessor 43 of the control board 42; ending the application of negative pressure of the dosing chamber when a predetermined pressure value is reached in the dosing chamber; temporarily opening of the first valve seat 68 of the second valve arrangement 4 by applying a suitable control voltage to the piezo bender 70, whereby the first sealing element 71 is lifted from the first valve seat 68 and this results in a vacuum being applied to the pipetting tip 10; closing of the first valve seat 68 of the second valve arrangement 4 by reducing or switching off the control voltage for the piezo bender 70 of the second valve arrangement 32 when a predetermined pressure value is reached in the dosing chamber; provision of an overpressure by the fluid module 12 at the supply connection 6 of the dosing device 1; temporarily opening of the first valve of the first valve seat 68 of the first valve arrangement 3 by applying a suitable control voltage to the piezo bender 70, whereby the first sealing element 71 is lifted from the first valve seat 69 and an application of overpressure to the dosing chamber is brought about; controlling (closed loop) of the application of overpressure to the dosing chamber on the basis of sensor signals of the first pressure sensor arrangement 31, which sensor signals are provided to the microprocessor 43 of the control board 42; ending the application of overpressure to the dosing chamber when a predetermined pressure value is reached in the dosing chamber; temporarily opening the first valve seat 68 of the second valve arrangement 4 by applying a suitable control voltage to the piezo bender 70, whereby the first sealing element 71 is lifted from the first valve seat 68, resulting in the application of excess pressure to the pipetting tip 10; closing of the first valve seat 68 of the second valve arrangement 4 by reducing or switching off the control voltage for the piezo bender 70 of the second valve arrangement 32 when a predetermined pressure value is reached in the dosing chamber.

1. A dosing device for dosing liquids, comprising:
a channel plate in which a fluid channel extends between a supply connection;
an output connection;
a supply valve located at the supply connection;
an output valve located at the output connection; and
a controller which is electrically connected to the supply valve and the output valve,
wherein a tip coupling for coupling a pipetting tip is connected with the output connection and wherein the supply valve and/or the output valve is designed as a proportional valve.

2. The dosing device according to claim 1, wherein the fluid channel is connected to a vacuum connection of the channel plate, and wherein a vacuum valve is assigned to the vacuum connection and is electrically connected to the controller.

3. The dosing device according to claim 2, wherein at least one valve from the group comprising the supply valve, output valve, vacuum valve is a piezo valve.

4. The dosing device according to claim 2, wherein the supply valve and the vacuum valve are accommodated in a first valve housing which has a first input connection which is connected to the supply connection and which has a second input connection which is connected to the vacuum connection, and wherein the first valve housing has a first working connection which is connected to the output valve.

5. The dosing device according to claim 4, wherein the output valve is accommodated in a second valve housing which has a second input connection connected to the first working connection of the first valve housing and which has a second working connection connected to the output connection.

6. The dosing device according to claim 5, wherein the fluid channel has a first valve shaft to accommodate the first valve housing and has a second valve shaft to accommodate the second valve housing.

7. The dosing device according to claim 6, wherein a maximum dosing volume is determined by the first valve housing, the second valve housing and a fluid channel section extending between the first valve housing and the second valve housing and that a volume fraction of the fluid channel section at the maximum dosing volume is less than 20 percent.

8. The dosing device according to claim 6, wherein a first pressure sensor arrangement is arranged between the first valve shaft and the second valve shaft which first pressure sensor arrangement is electrically connected to the controller, and wherein a second pressure sensor arrangement is assigned to the output connection and is electrically connected to the controller.

9. The dosing device according to claim 8, wherein the first pressure sensor arrangement comprises a first pressure sensor having a first measuring range and a second pressure sensor having a second measuring range, the first measuring range and the second measuring range having an intersection.

10. The dosing device according to claim 1, wherein a feed pump is assigned to the supply connection and/or wherein a vacuum pump is assigned to the vacuum connection.

11. The dosing device according to claim 7, wherein the maximum dosing volume is less than 10 percent.
